(19) United States
(12) Patent Application Publication
(10) Pub. No.: US 2024/0230004 A1
(43) Pub. Date: Jul. 11, 2024

(54) INTEGRAL FLEXURE TAPPING SLEEVE

(71) Applicant: Mueller International, LLC, Atlanta, GA (US)

(72) Inventors: David Latimore Hughes, JR., Signal Mountain, TN (US); Timothy J. Mitchell, Hixson, TN (US)

(21) Appl. No.: 18/094,214

(22) Filed: Jan. 6, 2023

(51) Int. Cl. F16L 41/06; F16L 47/30

(52) U.S. Cl. CPC F16L 41/06; F16L 47/30

(57) ABSTRACT

A tapping sleeve is described comprising a flow channel. The flow channel comprises an inlet and an outlet. A shell partially surrounds the flow channel. The shell comprises a cap shell portion, a flexible shell region, a tapped shell portion, and a clamp extending across a circumferential reach between the tapped shell portion and the cap shell portion. The clamp extends across the circumferential reach between the tapped shell portion and the cap shell portion to secure the tapping sleeve on the pipe. In the closed position, the clamp couples the tapped shell portion to the cap shell portion, and the flexible shell region is interposed between and more flexible than the tapped shell portion and the cap shell portion.

### TECHNICAL FIELD

This disclosure relates to tapping sleeves for pipes and utilities. More specifically, this disclosure relates to adjustable fastening mechanisms for a tapping sleeve, for example, secured to a tapped pipe.

### BACKGROUND

Tapping sleeves cover a tapped line and generally comprise a pair of opposite hinges or clamps, such as a saddle hingedly coupled opposite a cap configured to clamp and capture a gasket against an outer surface of the pipe that is tapped. Tapping sleeves provide a mechanism to “hot tap” a utility line that is already in service without interruption of neighboring utility services. Tapping sleeves are a standard method for tapping a fluid utility main in a cost-effective manner and facilitate the secure connection with a fluid-tight seal with variable sizes and/or piping materials connected to the main line. The sleeve length typically provides a stable seal. In some aspects, the strength of the sleeve may be greater than the hoop stress capabilities of the tapped line, for example, when the sleeve is steel (e.g., stainless steel) and the main line is a PVC and/or HDPE variant.

### SUMMARY

It is to be understood that this summary is a limited overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a tapping sleeve. The tapping sleeve comprises a flow channel comprising an inlet, an outlet, and a shell partially surrounding the flow channel. The shell comprises a cap shell portion, a clamp, and a flexible shell region. The clamp extends across a circumferential reach between the tapped and cap shell portions. The clamp couples the tapped shell portion to the cap shell portion when the clamp is in a closed position. The flexible shell region is interposed between the tapped and cap shell portions. The flexible shell region is more flexible than the tapped shell portion and the cap shell portions.

In a further aspect, disclosed is a method of manufacturing a tapping sleeve. The method comprises cutting a series of kerfs axially through the planar ductile material. The planar ductile material can be bent into a three-dimensional shape (e.g., a “C” or “U” shape) to define a shell. The shell comprises a tapped shell portion comprising the port, a flexible shell region comprising the series of kerfs, and a cap shell portion. The method comprises coupling a clamp across a circumferential reach of the shell. The clamp can compressively couple the tapped shell portion to the cap shell portion across the circumferential reach.

In yet another aspect, disclosed is a method of installing a tapping sleeve. The method comprises flexing a flexible shell region of a shell by widening a shell between a tapped shell portion and a cap shell portion. The method further comprises sliding the circumferential reach over an outer diameter of a pipe and coupling a clamp extending across the circumferential reach between the tapped shell portion and the cap shell portion of the shell.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the Figures may be designated by matching reference characters for the sake of consistency and clarity.

FIG. 1 is a first-side elevated perspective view of a living hinge on a tapping sleeve with integral flexure, in accordance with one aspect of the current disclosure.

FIG. 2 is a second-side elevated perspective view, substantially opposite the first view of the living hinge on a tapping sleeve with the integral flexure of FIG. 1.

FIG. 3 is a side perspective view of a flexible region of a living hinge that comprises a marked imprint of the flexible region in accordance with another aspect of the current disclosure.

FIG. 4 is an exploded view of the tapping sleeve with the flexible region of FIG. 3.

FIG. 5 is an elevated side perspective view of a tapping sleeve with slots in the flexible region extending in an axial direction of the tapping sleeve.

FIG. 6 is an elevated side perspective view of a tapping sleeve with slots in the flexible region extending in a transverse direction of the tapping sleeve.

FIG. 7 is an elevated side perspective view of a tapping sleeve with slots extending in the transverse direction and comprising an offset.

FIG. 8 is a side perspective view of a flexible region comprising a marked imprinted flexible region.

FIG. 9 is an elevated perspective view of one aspect of a mark in the flexible region, in accordance with the flexible region of Figure

FIG. 10 is a first-side elevated perspective view of one aspect of a flexible region of a tapping sleeve on a pipe comprising a coined flexible region.

FIG. 11 is a second-side elevated perspective view opposite the first elevated perspective view of FIG. 10, showing the coined flexible region of the tapping sleeve with the pipe removed.

FIG. 12 is a detailed side view of the coined flexible region on the tapping sleeve.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In one aspect, an integral flexure tapping sleeve is configured with a living hinge on one side and a clamp on the opposite side. The tapping sleeve is configured with an integral flexure that can use a flexible region to open the sleeve (e.g., over the outer diameter of an existing pipe), and the clamp is tightened to form a water-tight seal. The tapping sleeve with integral flexure and associated methods, systems, devices, and various apparatuses are disclosed herein.

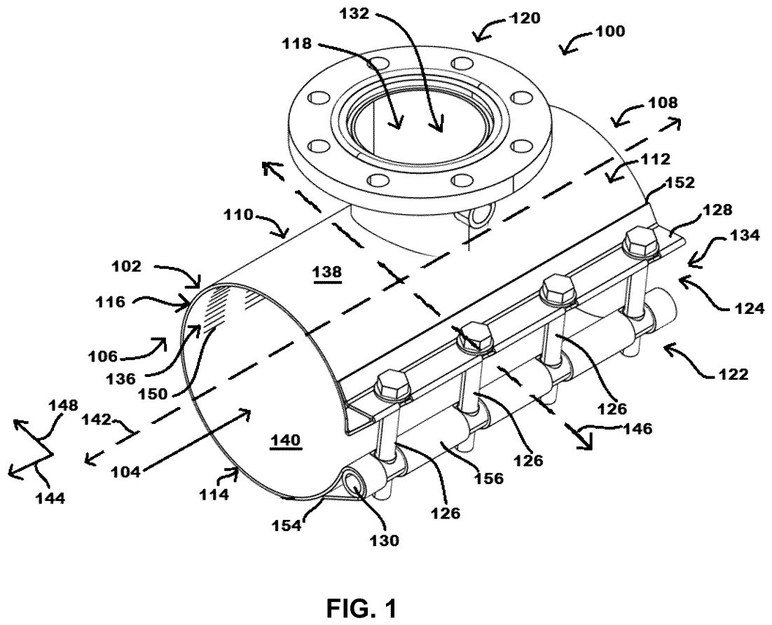

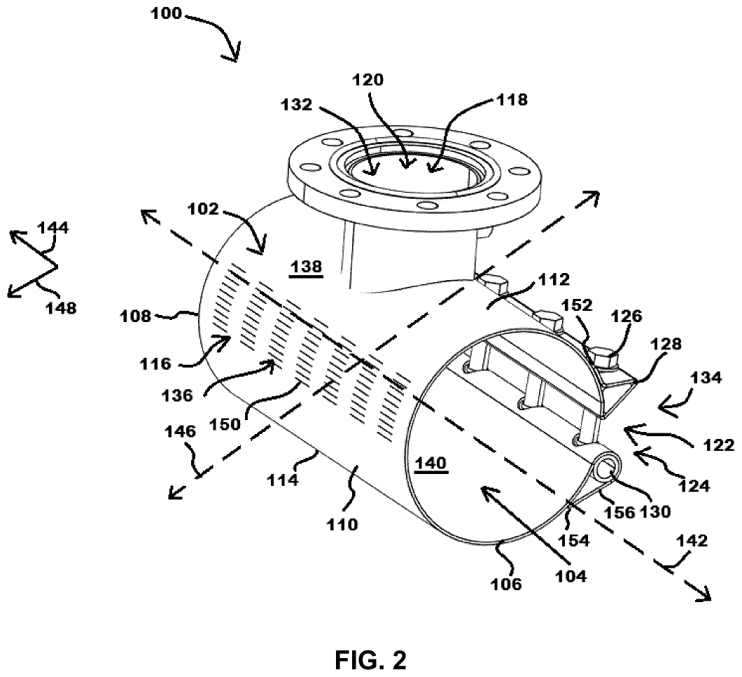

FIG. 1 is a first-side elevated perspective view of a tapping sleeve 100 with integral flexure comprising a living hinge 102 on the tapping sleeve 100. FIG. 2 is a second-side elevated perspective view of the tapping sleeve 100 shown in FIG. 1. In aspects shown in FIGS. 1 and 2, the tapping sleeve 100 comprises a flow channel 104 comprising an inlet 106 and an outlet 108.

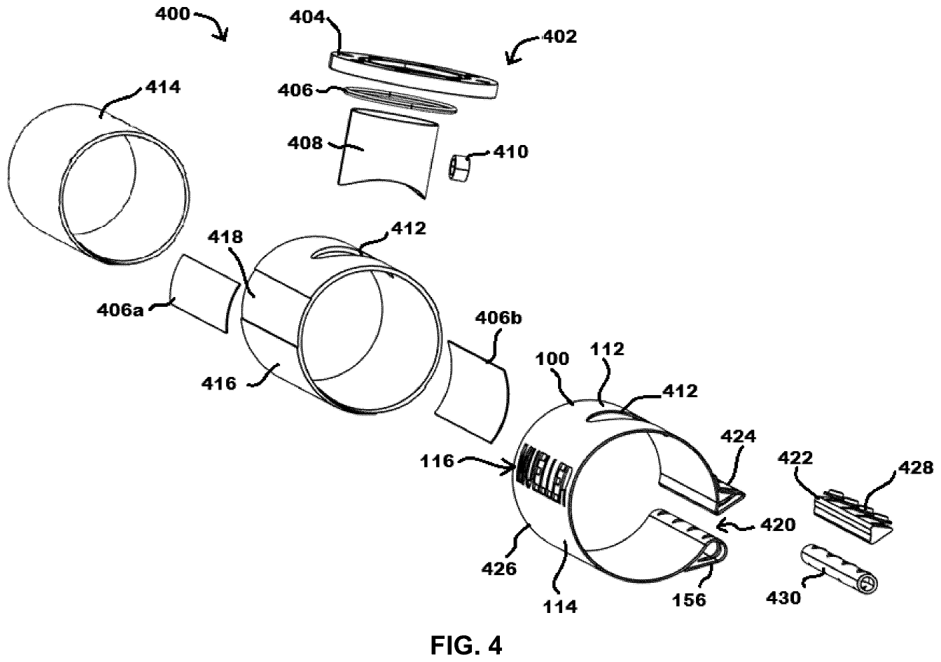

A shell 110 of the tapping sleeve 100 is configured to partially surround the flow channel 104 when the shell 110 is compressed, coupled, and/or attached to a tapped pipe (e.g., main 414 in FIG. 4). The shell 110 comprises a tapped shell portion 112 coupled to a cap shell portion 114 via a flexible shell region (labeled as flexible region 116). In various aspects, a tapped channel 118 extends through the tapped shell portion 112 approximately perpendicular to the flow channel 104 and comprises a second outlet 120 of the tapping sleeve 100. The inlet 106 of the tapping sleeve 100 is in fluid communication with the first outlet 108 and the second outlet 120. The shell 110 comprises a clamp 122 opposite the flexible region 116 and coupling the tapped shell portion 112 to the cap shell portion 114. The clamp 122 extends across a circumferential reach 124 opposite the flexible region 116. The circumferential reach 124 extends between and/or across the tapped shell portion 112 and the cap shell portion 114 such that when the clamp 122 is tightened and/or compressed, the sleeve 100 is compressed around an outer diameter of the tapped pipe (e.g., utility main 414 in FIG. 4). For example, rather than providing a separate upper shell (e.g., tapped shell) that is opposite a lower shell (or cap) and coupled with fasteners on both sides, the shell 110 comprises the tapped shell portion 112 that is monolithic with the cap shell portion 114. The shell 110 is monolithic because the flexible region 116 is interposed between and integral with the tapped shell portion 112 and the cap shell portion 114.

The clamp 122 can further comprise a spanner 126. The spanner 126 extends across the circumferential reach 124 and couples the tapped shell portion 112 to the cap shell portion 114. For example, the spanner 126 can rotate to close the clamp 122. For example, the spanner 126 can be a bolt that extends from a protrusion 128 on the tapped shell portion 112 to a receiving bar 130. The receiving bar can be captured within the cap shell portion 114, and the bolt (e.g., spanner 126) can be threaded to the receiving bar 130 to tighten the clamp 122 and seal the tapping sleeve 100.

The tapped shell portion 112 defines an opening or tapping port 132 that receives the tapped channel 118 into the shell 110 when sealed by the clamp 122. In various aspects, the clamp 122 is configured to releasably couple and/or tighten the tapped shell portion 112 to the cap shell portion 114 when the clamp is in a closed position 134. The flexible region 116 extends between the tapped shell portion and the cap shell portion. Similar to the clamp 122, the flexible region 116 is interposed between the tapped shell portion 112 and the cap shell portion 114, e.g., on the side of tapping sleeve 100 opposite clamp 122. In some aspects, the flexible region 116 can be more flexible than either the tapped shell portion 112 or the cap shell portion 114. Similarly, the clamp 122 can create a hoop stress in the shell 110 that is supported by the flexible region 116 opposite the clamp 122.

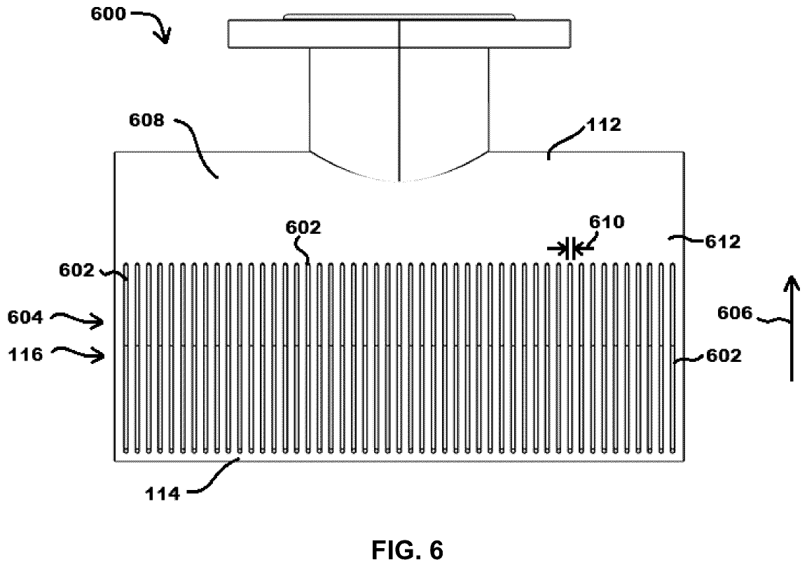

In various aspects, the flexible region 116 can define a plurality of slots 136 that extend from an outer surface 138 of the shell to an inner surface 140 of the shell 110. For example, the slots 136 can extend entirely or completely through the shell 110 to form a series of perforations that form the flexible region 116. FIGS. 1 and 2 show that the plurality of slots 136 can be substantially parallel to an axial axis 142 that defines an axial direction 144 extending through the tapping sleeve 100. The axial axis extends along the flow direction in the flow channel 104 of the sleeve 100. In other aspects, the tapping sleeve 100 can comprise a plurality of slots 136 that are parallel to a transverse axis 146 extending in a direction generally perpendicular to the flow direction (e.g., the transverse direction 148) in the flow channel 104 of the sleeve 600, for example, as shown in FIG. 6.

The tapping sleeve 100 can comprise a metallic material, such as steel, and more specifically, stainless steel. The thickness of the shell 110 can be at least 0.100 inches thick. In some aspects, the thickness of various components of the shell 110 can be different. For example, the thickness of the tapped shell portion 112 and/or the cap shell portion 114 of the shell is at least 0.100 inches thick, and the thickness of the flexible region 116 can be equal to or less than 0.100 inches thick.

In some aspects, a method of manufacturing the tapping sleeve 100 can comprise cutting a series of kerfs 150, for example, along an axial direction 144, through a planar ductile material that is bent from the planar ductile material into a three-dimensional shape (e.g., a C-shape). The three-dimensional shape can define a shell 110 of a taping sleeve 100 comprising the tapped shell portion 112, a flexible region 116, and a cap shell portion 114. The tapped shell portion 112 comprises the port 132, and the flexible region 116 comprises a series of kerfs 150. The cap shell portion 114 extends opposite the tapped shell portion 112 opposite the cap shell portion 114. The planar ductile material can be cut to form a top edge 152 and a bottom edge 154. The top edge 152 can be bent to define the tapped shell portion 112, and the bottom edge 154 can be bent to define the cap shell portion 114.

The clamp 122 can be coupled across the circumferential reach 124 formed in the 3-dimensional shell 110. For example, the clamp 122 can compressively couple the tapped shell portion 112 to the cap shell portion 114 across the circumferential reach 124. Tightening the clamp 122 across the circumferential reach 124 of the shell 110 can change a hoop force/stress in the flexible region 116. For example, the hoop force/stress in the flexible shell region can change from compression to tension when the clamp 122 is tightened.

The protrusion 128 can be coupled to and/or extended from the tapped shell portion 112 and/or the cap shell portion 114 to facilitate tightening the spanner 126 across the circumferential reach 124. The protrusion 128 can span the circumferential reach to a ridge 156 extending from the cap shell portion 114 and/or the tapped shell portion 112. For example, the protrusion can extend from the tapped shell portion 112, and the cap shell portion 114 can comprise the ridge 156. Similarly, the ridge 156 can be coupled to the tapped shell portion, and the protrusion can extend from the cap shell portion 114. The spanner 126 can then be inserted across the circumferential reach 124 and threadedly coupled to a receiving bar 130 inserted within the ridge 156 to fasten the spanner 126 across the circumferential reach 124. The spanner 126 can extend from the protrusion 128 to the receiving bar 130 when the protrusion is coupled to the tapped shell portion 112 or the cap shell portion 114, and the ridge 156 is coupled to the opposite cap shell portion 114 or tapped shell portion 112.

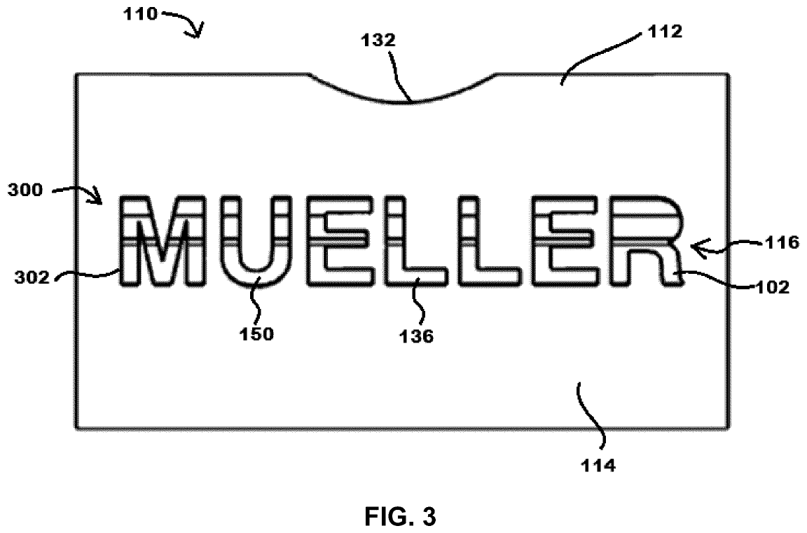

FIG. 3 shows the flexible region 116 of a living hinge 300 that comprises a marked imprint 302 of the flexible region 116. For example, as shown in FIG. 3, the registered trademark “MUELLER” ® is applied to a side of the living hinge 300. The living hinge 300 is the same as or similar to the living hinge 102 and includes a flexure or flexible region 116. Material within the flexible region 116 can be removed and/or modified to create the living hinge 300 that is bent over a pipe and maintain circumferential tension when coupled and clamped to the pipe. That is, the flexibility in the flexible region 116 enables a user to open the living hinge 300 and fit the living hinge 300 over the pipe, all while maintaining the circumferential tension to support the hoop loads generated in the flexible region 116 when the living hinge 300 is fastened and clamped onto the pipe.

FIG. 3 demonstrates that the flexible region 116 can have a modified or altered flexibility from the tapped shell portion 112 and/or the cap shell portion 114. That is, the flexibility of the shell 110 can vary throughout the shell 110. The flexible region 116 is modified to provide enhanced flexibility relative to the tapped shell portion 112 and the cap shell portion 114. The flexible region 116 also provides a hinge area or compliant section that a user can bend by hand and open the shell 110 to locate the shell 110 over the pipe. The flexible region 116 maintains structural rigidity so that when the shell 110 is closed and tightened, the flexible region 116 can carry the hoop stresses generated through the clamped shell 110 and maintain the part's life. Different slots 136 or reliefs can be generated with a mechanical saw or a laser. For example, a zero-thickness slot 136 has a near-zero width (or kerf 150). The kerf 150 of the slot 136 can depend on the number of passes of the laser, such that the zero-thickness slot 136, or near zero-thickness slot 136, can be faster to cut on the laser than a wide kerf 150.

The benefits of a shell 110 comprising a flexible region 116 include reduced expenses, enhanced operational use of the shell 110 in different pipe configurations, and a reduced number of components. For example, the process of manufacturing the shell 110 can be reduced because there are fewer independent parts in the shell 110 assembly and a reduced number of processes involved in manufacturing the shell 110.

FIG. 4 shows a tapping sleeve assembly 400 with the flexible region 116 of FIG. 3. In various aspects, the same tapping sleeve assembly 400 can be used for any tapping sleeve assembly 400 disclosed herein. A mechanical joint or branch outlet 402 can comprise a flange 404 with a gasket 406 coupled to a branch tube 408. The branch tube 408 can comprise a test port 410 and plug and can be inserted into the port 412 created by tapping into the pipe or utility main 414.

The utility main 414 can extend through a metallic armor 416 configured with cutouts or recesses 418 to receive gaskets 406a,b. For example, gaskets 406a,b can facilitate a fluid-tight seal between the armor 416 and the shell 426. Moreover, gasket 406a can facilitate the fluid-tight seal in the flexible region 116, and gasket 406b can facilitate the fluid-tight seal across the circumferential reach 420.

A flat washer assembly 422 can be inserted into a protrusion 424 of shell 426 to support the spanners 428. Similarly, the receiving bar 430 is configured to receive the spanner 428 and can be inserted within a ridge 432 of the shell 426. As shown in FIG. 4, the protrusion 424 extends from the tapped shell portion 112, and the ridge 156 extends from the cap shell portion 114, but as explained above, the protrusion 424 can extend from the cap shell portion 114, and the ridge 156 can extend from the tapped shell portion 112.

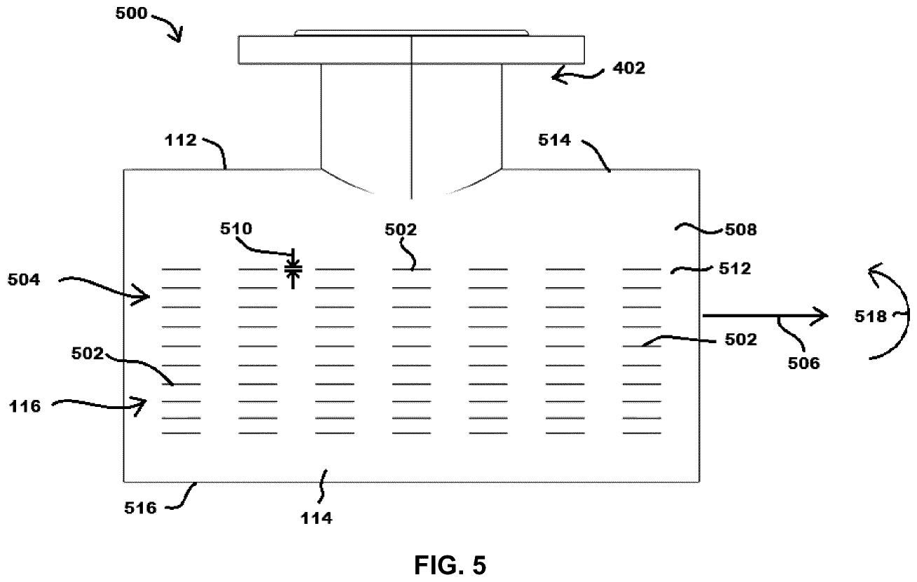

FIG. 5 shows a tapping sleeve 500, the same as or similar to sleeve 100, with slots 502 in the flexible region 504 extending along the axial direction 506 of the tapping sleeve 500. The area of the flexible region 504 and the orientation of the slots 502 define the flexible region 504 of the shell 508. For example, the flexible region 504 defines an axial kerf 510 extending through at least 40% of an axial direction 506 of the flexible region 504. Specifically, the flexible region 504 can extend through at least 50% of the flexible region 504. More specifically, the flexible region 504 can comprise between 40-60% of side 512 of the sleeve 500. That is, the slots 502 in the flexible region 504 can extend through the flexible region 504 extend across 40-60% of the area between a top 514 to a bottom 516 of the flexible region 504, e.g., in the circumferential direction 518. In this configuration, hoop stress in the flexible shell region 504 can be at least double of hoop stress in the tapped shell portion 112 and/or hoop stress in the cap shell portion 114.

FIG. 6 shows a tapping sleeve 600 comprising transverse slots 602 in the flexible region 604 that extend in the transverse direction 606 of the shell 608 of the tapping sleeve 600. The flexible region 604 defines a transverse kerf 610 extending through at least 40%, or at least 50% of the flexible region 604, between the tapped shell portion 112 and the cap shell portion 114. Similar to the tapping sleeve 500, tapping sleeve 600 can comprise between 40-60% of a side 612 of the sleeve 600, but the kerf 610 extends along the transverse direction 606.

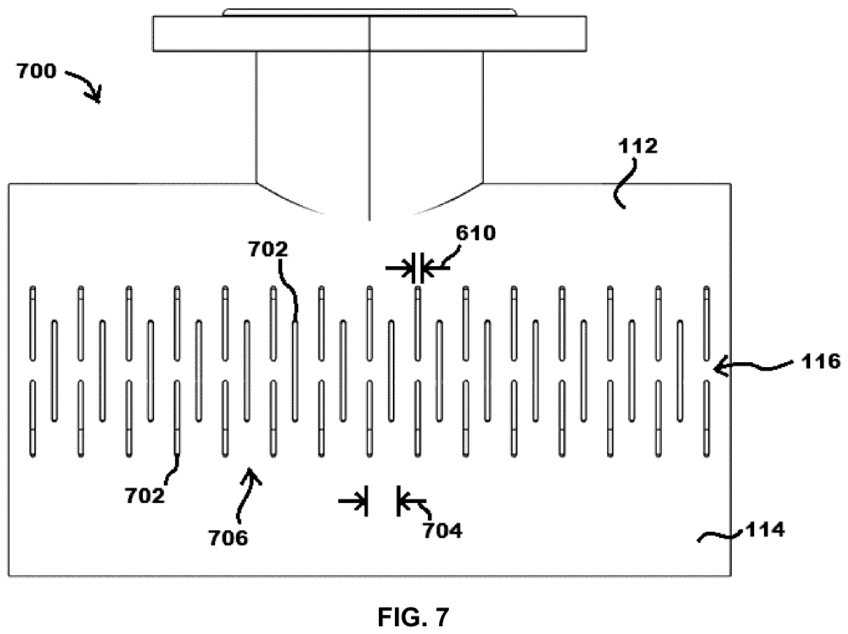

FIG. 7 shows a tapping sleeve 700 with slots 702 extending in the transverse direction 606 and comprising an offset 704. The configuration of FIG. 7 differs from FIG. 6 because the offset 704 creates a repeating pattern 706, where each transverse kerf 610 differs from the next adjacent transverse kerf 610 but does so in a repeating pattern. In various aspects, the pattern can repeat every other (e.g., second) transverse kerf 610 or can repeat every third, fourth, or more repeating transverse kerfs 610, each defining an offset 704 defined by the number of transverse kerfs 610 to establish the first iteration of the repeating pattern 706.

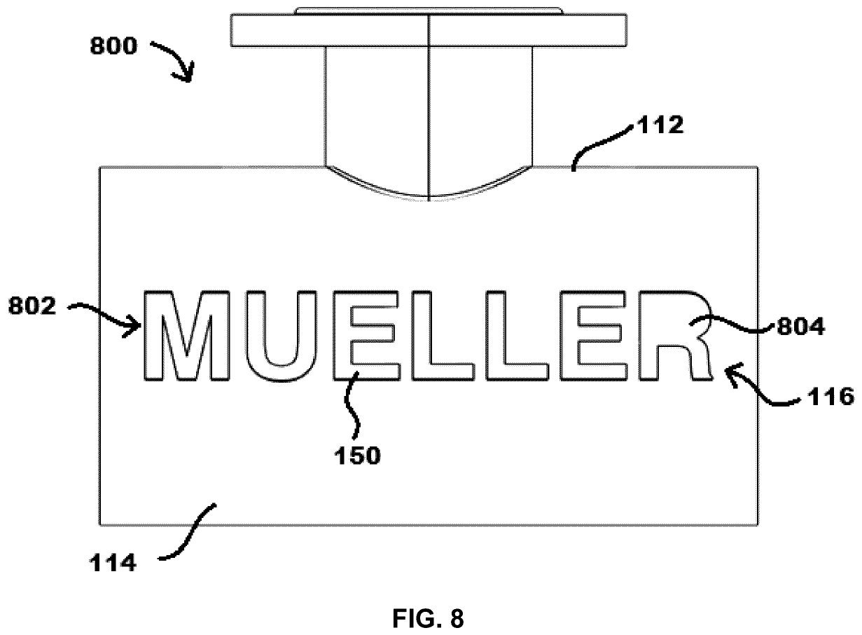

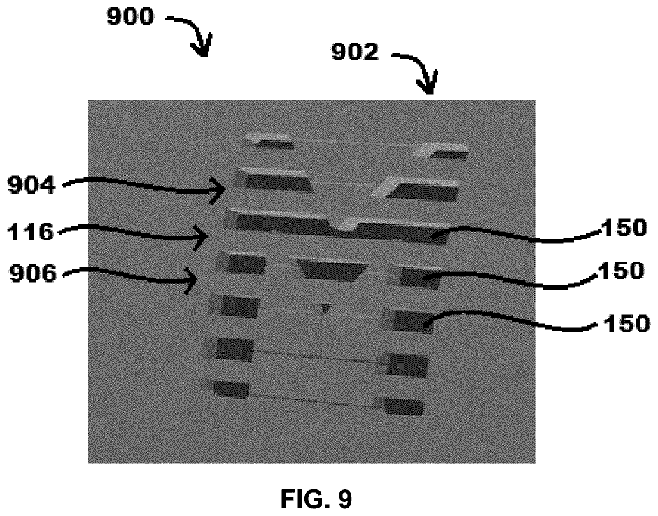

FIG. 8 is a tapping sleeve 800 comprising a flexible region 802 comprising a marked imprint 804 in the flexible region 802, such as a mark comprising the MUELLER® trademark. The flexible region 802 with the marked imprint 804 in the flexible region 802 differs from the mark, e.g., in FIG. 3, as the entire imprinted flexible region 802 is cut out. In contrast, the marked imprint 302 of FIG. 3 comprises a series of overlapping kerfs 150 or cuts to create the imprint. For example, FIG. 9 illustrates this aspect for a tapping sleeve 900 with a mark 902 in the flexible region 904 and comprising a series of kerfs 150 that are laser cut in a pattern 906 to create a textured mark imprinted in the flexible region 904.

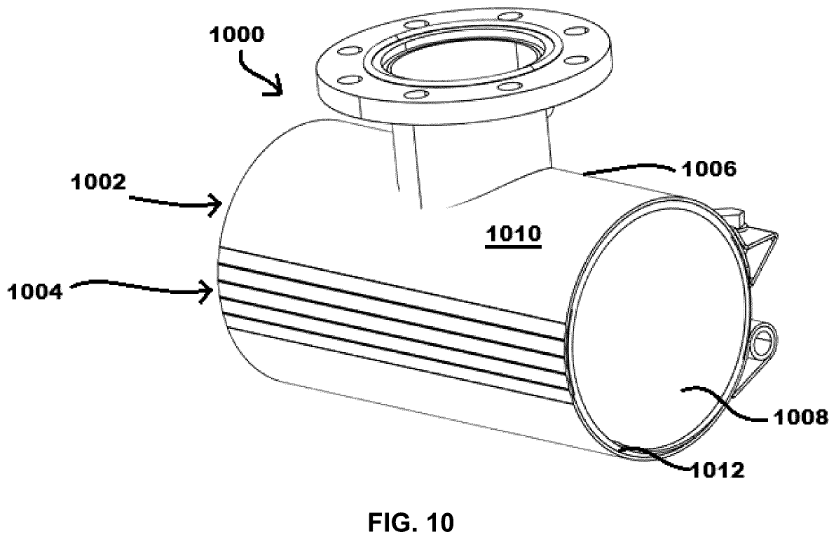

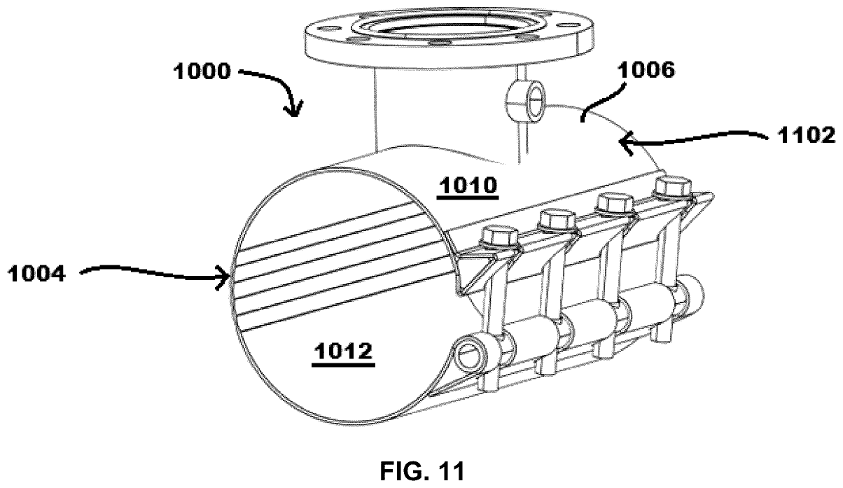

FIG. 10 shows a tapping sleeve assembly 1000 on a first side 1002 of comprising a coined flexible region 1004 of a shell 1006 on a pipe 1008. FIG. 11 is a second side 1102 of the tapping sleeve assembly 1000 of FIG. 10, with the pipe and interior features removed to show the coined flexible region 1004 of the tapping sleeve assembly 1000 with the pipe removed.

The coined flexible region 1004 can be the same or similar to the flexible region 116 described above, except that the coined flexible region 1004 comprises variable thicknesses between a maximum and minimum thickness. In the coined flexible region 1004, no kerf 150 extends entirely through the coined flexible region 1004, e.g., from an outer surface 1010 to an inner surface 1012 of the shell 1006.

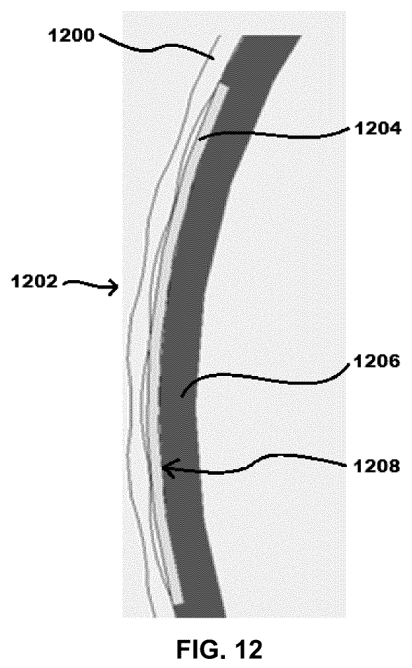

FIG. 12 is a detailed side view of tapping sleeve 1200 comprising a coined flexible region 1202 on the tapping sleeve 1200, and a gasket 1204 disposed within the armor 1206. As shown, the coined flexible region 1202 is sized to match the area over the gasket 1204 and disposed within a recess 1208 of the armor 1206.

The flexible region 1202 can comprise the coined flexible region 1202 and/or one or more kerfs 150. The coined flexible region 1202 can comprise a variable thickness. For example, the thickness of the coined flexible region 1202 can fluctuate between a maximum and a minimum thickness, such that the thickness is variable. In some aspects, the maximum thickness is less than or equal to the thickness of the tapped shell portion 112 and/or the thickness of the cap shell portion 114. The minimum thickness can be equal to or less than half of the maximum thickness. As described above, the thickness of various components of the shell 110 can be different. For example, the thickness of the tapped shell portion 112 and/or the cap shell portion 114 of the shell is at least 0.100 inches thick, and the thickness of the flexible region 1202 can be equal to or less than 0.100 inches thick.

Regarding FIGS. 1 to 12, a method for installing a tapping sleeve 100 comprises flexing the flexible region 116 of the shell 110. In some aspects, the flexible region 116 is flexed by widening the shell 110 between the tapped shell portion 112 and the cap shell portion 114. The circumferential reach 124 of the shell 110 can then slide over the outer diameter of a pipe, and the clamp 122 can be coupled to extend across the circumferential reach 124. The clamp 122 extends between the tapped shell portion 112 and the cap shell portion 114 of the shell 110 to secure the tapping sleeve 100 across the circumferential reach 124. In some aspects, the clamp can be tightened to extend across the circumferential reach 124 and apply a tensile force to the flexible region 116 interposed between the tapped shell portion 112 and the cap shell portion 114 of the shell 110. In various aspects, the flexible region 116 can comprise a kerf 150 extending through the thickness of the shell 110 and/or a variable thickness that reduces a moment of inertia relative to a flexural axis (e.g., axial axis 142) extending axially through the flexible region 116.

The description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, and processes and between different models, the tolerance for a particular measurement of a particular component can fall within a range of tolerances.

As used herein, the terms “optional” or “optionally” mean that the subsequently described event or circumstance may or may not occur and that the description comprises instances where said event or circumstance occurs and instances where it does not.

The word “or” as used herein means any one member of a particular list and also comprises any combination of members of that list. The phrase “at least one of A and B,” as used herein, means “only A, only B, or both A and B,”; while the phrase “one of A and B” means “A or B.”

Unless the context dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless expressly stated otherwise, or otherwise understood within the context as used, is generally intended to convey that certain aspects include, while other aspects do not include, certain features, elements and/or steps. Thus, such conditional language is not generally intended to imply that features, elements, and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A tapping sleeve comprising:
a flow channel comprising an inlet and an outlet; and
a shell partially surrounding the flow channel, the shell comprising:
a tapped shell portion;
a cap shell portion opposite the tapped shell portion;
a clamp extending across a circumferential reach extending between the tapped shell portion and the cap shell portion, the clamp configured to couple the tapped shell portion to the cap shell portion when the clamp is in a closed position; and
a flexible shell region interposed between and more flexible than the tapped shell portion and the cap shell portion.

2. The tapping sleeve of claim 1, wherein the outlet is a first outlet and the inlet is in fluid communication with the first outlet and a second outlet.

3. The tapping sleeve of claim 1, wherein the flexible shell region defines an axial kerf extending through at least 40% of an axial direction of the flexible shell region.

4. The tapping sleeve of claim 1, wherein the flexible shell region comprises between 40-60% of a side-sleeve extending through the flexible shell region from a top to a bottom of the flexible shell region in a circumferential direction.

5. The tapping sleeve of claim 1, wherein hoop stress in the flexible shell region is at least double of hoop stress in the tapped shell portion and hoop stress in the cap shell portion.

6. The tapping sleeve of claim 1, wherein a thickness of the shell is at least 0.100 inches thick.

7. The tapping sleeve of claim 1, wherein a thickness of the tapped shell portion and the cap shell portion of the shell is at least 0.100 inches thick, and a thickness of the flexible shell region is equal to or less than 0.100 inches thick.

8. The tapping sleeve of claim 1, wherein the clamp further comprises a spanner that couples the tapped shell portion to the cap shell portion and extends across the circumferential reach, the spanner being configured to close the clamp.

9. The tapping sleeve of claim 8, wherein the spanner is a bolt extending from a protrusion on the tapped shell portion to a receiving bar captured within the cap shell portion, and the bolt threadedly engages the receiving bar to tighten the clamp.

10. The tapping sleeve of claim 1, wherein the flexible shell region comprises a variable thickness that fluctuates between a maximum thickness and a minimum thickness.

11. The tapping sleeve of claim 10, wherein the maximum thickness is less than or equal to a thickness of the tapped shell portion and a thickness of the cap shell portion.

12. The tapping sleeve of claim 10, wherein the minimum thickness is equal to or less than half of the maximum thickness.

13. The tapping sleeve of claim 1, wherein the flexible shell region defines a slot that extends from an outer surface of the shell to an inner surface of the shell, and the slot extends entirely through the shell.

14. The tapping sleeve of claim 1, wherein the flexible shell region defines a plurality of slots.

15. The tapping sleeve of claim 14, wherein the plurality of slots are parallel to an axial axis extending through a flow direction in the flow channel of the sleeve.

16. The tapping sleeve of claim 14, wherein the plurality of slots are parallel to a transverse axis extending perpendicular to a flow direction in the flow channel of the sleeve.

17. A method of manufacturing a tapping sleeve, comprising:
cutting a series of kerfs axially through a planar ductile material;
bending the planar ductile material into a three-dimensional C-shape to define a shell comprising a tapped shell portion comprising a port, a flexible shell region comprising kerfs, and a cap shell portion; and
coupling a clamp across a circumferential reach of the shell, the clamp is configured to compressively couple the tapped shell portion to the cap shell portion across the circumferential reach.

18. The method of claim 17, further comprising tightening the clamp extending across the circumferential reach of the shell to change a hoop force in the flexible shell region from compression to tension.

19. The method of claim 17, further comprising cutting the planar ductile material to form a top edge and a bottom edge, and wherein the top edge defines the tapped shell portion and the bottom edge defines the cap shell portion.

20. The method of claim 17, further comprising bending a protrusion coupled to and extending from one of the tapped shell portion and the cap shell portion; and bending a ridge extending from the other of the cap shell portion and the tapped shell portion.

21. The method of claim 20, further comprising inserting a spanner across the circumferential reach and inserting a receiving bar within the ridge, wherein the spanner extends from the protrusion to the receiving bar.

22. The method of claim 17, wherein the flexible shell region defines a slot that extends from an outer surface of the shell to an inner surface of the shell, and the slot extends completely through the shell, and the flexible region defines a plurality of slots.

23. The method of claim 22, wherein the plurality of slots are parallel to an axial axis extending through a flow direction in the sleeve.

24. The method of claim 22, wherein the plurality of slots are parallel to a transverse axis extending perpendicular to a flow direction in the sleeve.

25. A method of installing a tapping sleeve comprising:
flexing a flexible shell region of a shell by widening the shell between a tapped shell portion and a cap shell portion;
sliding a circumferential reach over an outer diameter of a pipe; and
coupling a clamp extending across the circumferential reach defined between the tapped shell portion and the cap shell portion of the shell.

26. The method of claim 25, further comprising tightening the clamp extending across the circumferential reach to apply a tensile force to the flexible shell region interposed between the tapped shell portion and the cap shell portion of the shell.

27. The method of claim 25, wherein the flexible shell region comprises a variable thickness that reduces a moment of inertia relative to a flexural axis extending axially through the flexible shell region.
